(19) United States
(12) Patent Application Publication
(10) Pub. No.: US 2009/0308729 A1
(43) Pub. Date: Dec. 17, 2009

(54) HYDROGEN PRODUCTION FROM WATER USING A PLASMA SOURCE

(76) Inventors: ALEC D. GALLIMORE, Ann Arbor, MI (US); Son-Ca Viet Thi Nguyen, Ann Arbor, MI (US)

Correspondence Address: HARNESS, DICKEY & PIERCE, P.L.C., P.O. BOX 828, BLOOMFIELD HILLS, MI, 48303, US

(21) Appl. No.: 12/483,292

(22) Filed: Jun. 12, 2009

Related U.S. Application Data
(60) Provisional application No. 61/061,160, filed on Jun. 13, 2008.

(51) Int. Cl. C01B 3/02; B01J 19/08; B01J 19/12; G01N 33/00

(52) U.S. Cl. 204/156; 422/186.04; 422/186.03; 422/83; 204/164

(57) ABSTRACT

An apparatus and method for hydrogen production by dissociating water molecules in response to plasma output from a plasma source. This plasma source can have an RF antenna, capable of operating in capacitive, inductive, or helicon mode when operating conditions match those required to excite these modes. Hydrogen is produced by injecting water vapor into the plasma source. According to the principles of the present teachings, the apparatus and method are, thus, capable of dissociating water molecules into their constituent species.

### CROSS-REFERENCE TO RELATED APPLICATIONS

This application claims the benefit of U.S. Provisional Application No. 61/061,160, filed on Jun. 13, 2008. The entire disclosure of the above application is incorporated herein by reference.

### FIELD

The present disclosure relates to hydrogen production and, more particularly, relates to hydrogen production from water using a plasma source.

### BACKGROUND AND SUMMARY

This section provides background information related to the present disclosure which is not necessarily prior art. This section also provides a general summary of the disclosure, and is not a comprehensive disclosure of its full scope or all of its features.

Hydrogen has been proposed as an alternative source of energy carrier. However, hydrogen is currently not a sustainable form of energy because approximately 96% of hydrogen is produced from natural resources including methane, oil, and coal. At least two problems arise in these current methods of hydrogen production from hydrocarbons, namely expected shortage of natural resources in the near future and carbon dioxide emissions.

Therefore, electrolysis has become the main renewable method, contributing to 3.8% of total hydrogen production. However, this technique has approximately 25% energy efficiency, when including the electricity efficiency used for its production, and this technique also requires expensive catalysts for completion. Hence, its usefulness may be reduced.

To address the need to make hydrogen a sustainable form of energy, the principles of the present teachings provide a new technique of hydrogen production using a plasma source. Similar to electrolysis, water is used to produce hydrogen through the present teachings. However, unlike electrolysis, the O—H bonds are more efficiently dissociated in a plasma source due to its high energy. Previous works have recognized the promising potential of plasma for hydrogen production, but have used plasma to break up only hydrocarbons or have used it in a form of a catalyst. The present disclosure sets forth results of various experiments and examines the effect of RF power and magnetic field strength on plasma species composition when water is injected into an inductive plasma source. The capability to dissociate water molecules into hydrogen and oxygen is demonstrated.

Therefore, according to the present teachings, an apparatus and method for hydrogen production by dissociating water molecules in response to plasma output from a plasma source is provided. This plasma source can have a optional RF helicon antenna, capable of operating in capacitive, inductive, or helicon mode when operating conditions match those required to excite these modes, or can be of the nature of an atmospheric plasma source such as a torch or a dielectric barrier discharge, for example. Hydrogen can be produced by injecting water vapor into the plasma source.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an apparatus according to the principles of the present teachings;

FIG. 2 is a schematic view of a plasma source of the apparatus according to the principles of the present teachings;

FIG. 3 is a schematic view of a residual gas analyzer according to the principles of the present teachings;

FIG. 4 is a graph illustrating species identification and the disassociation of water;

FIG. 5 is a graph illustrating the pressure ratio of hydrogen;

FIG. 6 is a graph illustrating the pressure ratio of oxygen;

FIG. 7 is a graph illustrating the pressure ratio of hydroxyl; and

FIG. 8 is a graph illustrating the pressure ratio of water vapor.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present teachings provide a novel technique of hydrogen production by dissociating water molecules in a radio-frequency (RF) plasma. This plasma source has an RF antenna, capable of operating in capacitive, inductive, or helicon mode when operating conditions match those required to excite these modes. Hydrogen is produced by injecting water vapor into a RF plasma source. The species identified in the plasma from data obtained via a residual gas analyze are hydrogen, oxygen, water, hydroxyl, and nitrogen. Partial pressures of these gases are also obtained from the residual gas analyzer. In other words, according to the principles of the present teachings, this plasma source is capable of dissociating water molecules into their constituent species when operating in inductive mode, suggesting that this method has a potential to generate hydrogen for industrial hydrogen production application.

### Apparatus

### A. Vacuum Facility

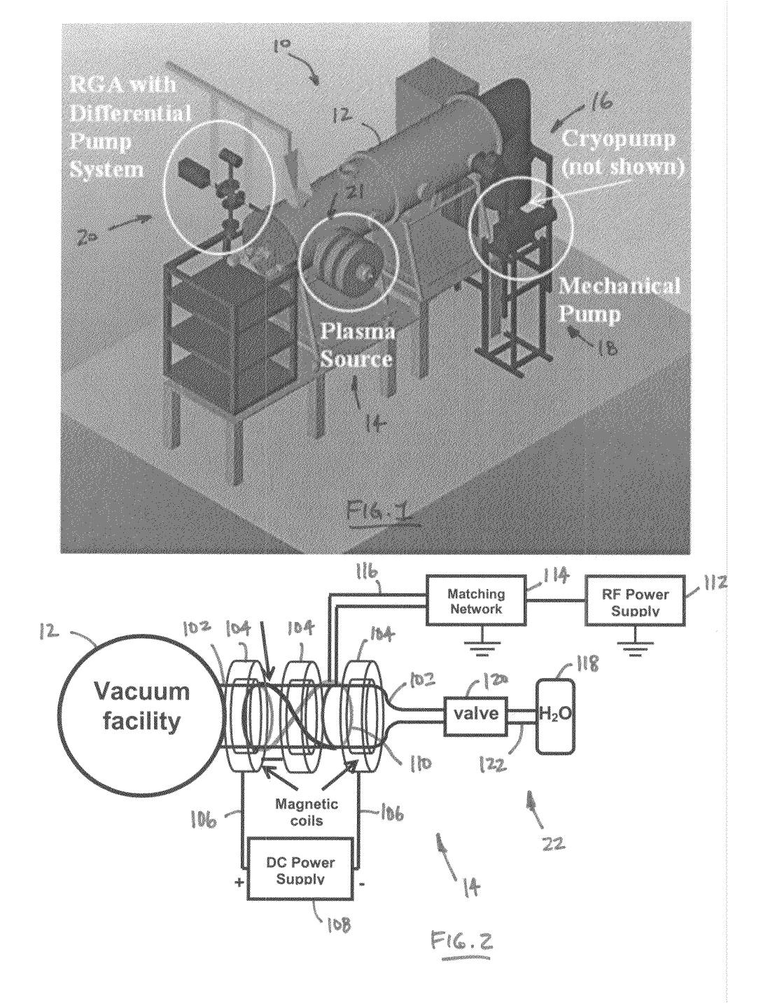

With reference to FIGS. 1-3, an apparatus 10 is illustrated for hydrogen production by dissociating water molecules in plasma. In some embodiments, apparatus 10 can comprise a main cylindrical vacuum chamber 12 having a plasma source 14 operably coupled thereto, a cryopump 16, a mechanical pump 18, and a residual gas analyzer (RGA) with differential pump system 20. In some embodiments, apparatus 10 may include merely a plasma source 14, a container or chamber 12 for containing hydrogen, and, perhaps, sensors to monitor the overall system and/or output.

In some embodiments, vacuum chamber 12 can be about 2-meter long and 0.6-meter in diameter. However, it should be appreciated that smaller chambers and overall assemblies are envisioned and within the scope of the present teachings. In fact, it should be understood that open-air containers or other vessels can be used as an alternative to vacuum chamber 12.

In some embodiments, mechanical pump 18 can be an Edwards 2-Stage pump operating at a pressure limit of 50×10⁻³ torr (6.7 Pa) before oil back streams into vacuum chamber 12. When mechanical pump 18 is operated alone, a pressure within vacuum chamber 12 can be set above this limit. Alternatively, cryopump 16 can be a CVI 20-inch cryopump that is capable of bringing the base pressure to 3×10⁻⁷ torr (4×10⁻⁵ Pa), whereby mechanical pump 18 can then be used as a roughing pump in this case.

It should be understood, however, that in some embodiments vacuum chamber 12 can be maintained at pressures other than those specifically enumerated herein. For example, it should be understand that vacuum chamber 14 can be maintained at atmospheric pressure, a positive pressure, or a negative pressure depending on the plasma source used.

### B. Plasma Source

Referring now to FIG. 2, plasma source 14 is schematically illustrated. Although plasma source 14 will be described in connection with an radio-frequency (RF) plasma source, it should be understood that alternative plasma sources are envisioned, including dielectric barrier discharge (DBD) devices, microwave plasma sources, plasma torches, magnetrons, etc.

In some embodiments, plasma source 14 can be attached on a side port 21 of main cylindrical vacuum chamber 12 and can comprise a tubular member, such as a quartz tube, 102. By way of non-limiting example, quartz tube 102 can be about 15 cm in diameter and 50 cm in length. Plasma source 14 can further comprise a plurality of magnetic coils 104, such as three (as illustrated), circumferentially surrounding quartz tube 102 and generally co-axially aligned therewith. The plurality of magnetic coils 104 can generate magnetic fields with strength up to about 400 gauss within quartz tube 102 (generally at the axial center of the plurality of magnetic coils 104). The plurality of magnetic coils 104 can be electrically coupled in series via lines 106 to a DC power supply 108. DC power supply 108 can provide current up to 60 amperes to properly energize the plurality of magnetic coils 104.

A double helical antenna 110 can circumscribe quartz tube 102, and be positioned between quartz tube 102 and the plurality of magnetic coils 104 to permit operation in the helicon mode. Double helical antenna 110 is provided to transmit RF power inter the plasma, thus creating a capacitive, inductive, or helicon plasma, depending on the operating conditions of the source. To this end, double helical antenna 110 connects to an RF power supply and enables the plasma source to operate in either capacitive, inductive, or helicon mode when operating conditions match those required to excite these modes. However, as will be discussed herein, antenna 110 may be optional in some embodiments where RF plasma generation is not used.

A power supply 112, such as an RF power supply, can be electrically coupled to double helical antenna 110 through a matching network 114 via lines 116. RF power supply 112 can operate at 13.56 MHz and output up to 3 kilowatts of power.

Matching network 114 can be used to match the impedance of the output of power supply 112 to the impedance of double helical antenna 110. By matching the impedance of power supply 112 to that of antenna 110, the reflected power can be reduced to less than 2% for more efficient operation.

Still referring to FIG. 2, a water delivery system 22 is provided for producing and/or delivering water vapor. Water vapor can be produced in a separate vessel 118 and delivered to plasma source 14 via a mechanical valve 120 and lines 122. In some embodiments, water vapor can be produced in vessel 118 by heating the water to create steam, by creating small droplets by ultrasonic excitation, etc. To this end, mechanical valve 120 can be any type of valve capable of handling water vapor.

### C. Diagnostics—Residual Gas Analyzer

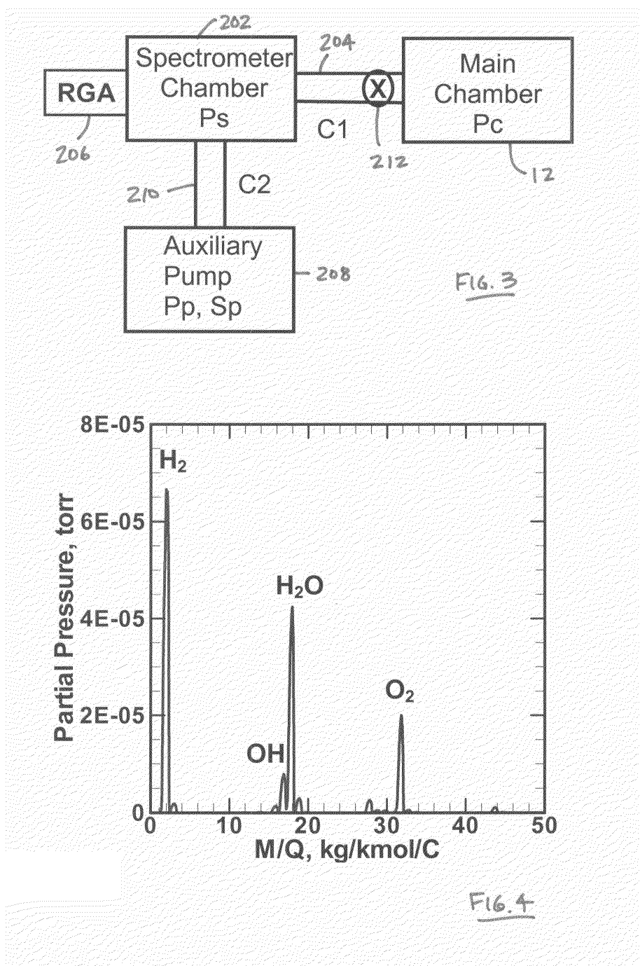

With reference to FIG. 3, a Kirk J Lesker residual gas analyzer (RGA) and differential pump system 20 is illustrated and can be used to identify gas species in the plasma. However, it should be understood that alternative detection or sensor devices may be used for detection and monitoring, such as Attorney Docket No. 2115-003671/US gas chromatographs, other types of mass spectrometers, or hydrogen detectors/detection equipment. Additionally, in some commercial applications, detection and/or monitoring may not be necessary once reliable operation is established.

Notwithstanding, in some embodiments, residual gas analyzer (RGA) and differential pump system 20 can measure the partial pressures of the gas species inside vacuum chamber 12. In some embodiments, as illustrated in FIG. 3, residual gas analyzer (RGA) and differential pump system 20 can comprise a spectrometer chamber 202 fluidly coupled to vacuum chamber 12 via a line 204. A residual gas analyzer (RGA) 206 is operably coupled to spectrometer chamber 202 for operation therewith.

Generally, in some embodiments, the operating pressure limit of RGA 206 is 10⁻⁴ torr (13×10⁻³ Pa) while the operating pressure of vacuum chamber 12 is about two orders of magnitude higher than this pressure limit. Accordingly, a differentially pumped system 208 is operably coupled with spectrometer chamber 202 via a line 210 and is operable to reduce the pressure within spectrometer chamber 202 prior to operation of RGA 206. Therefore, in operation, the plasma in vacuum chamber 12 enters spectrometer chamber 202 through a variable leak valve 212. In other words, differentially pumped system 208, which can be a turbomolecular pump from Varian® (model V70LP), can be used to pump gases out of spectrometer chamber 202, thereby maintaining the pressure of spectrometer chamber 202 below the pressure limit for operation of RGA 206.

$$Ps = \frac{Pc}{1 + ( \frac{C 2}{C 1} ) ( \frac{Sp}{Sp + C 2} )} C 2 << SP ↗ \qquad Eq . 1$$

Equation 1 relates the pressure in spectrometer chamber 202 to other parameters, where Ps is the pressure of spectrometer chamber 202, Pc is the pressure of vacuum chamber 12, C is the conductance, and Sp is the pumping speed. This expression is obtained by setting Q1 equal to Q2, which equals SpPp, where Q1 is the throughput in pipe 1 and Q2 is the throughput in pipe 2, and Pp is the pressure of the pump. Note that the pipe conductances C1 and C2 are both proportional to the square root of the mass of the gases while Sp depends on the pump type. In order to ensure that the gas in spectrometer chamber 202 is representative of the gas in vacuum chamber 12, C2 must be much less than Sp in Equation 1. The result leads to Equation 2, where again C1 and C2 have the same mass dependency.

$$Ps = \frac{Pc}{1 + ( \frac{C 2}{C 1} )} \qquad Eq . 2$$

### Results

The followings are results for 100-mtorr (13 Pa) chamber pressure operation. However, it should be appreciated to one skilled in the art that the principles of the present teachings are equally applicable for operation at other pressures. Gas species in the plasma were identified using raw RGA data.

Referring now to FIG. 4, a graph is provided having 40 different sets of RGA data containing 10 RF power settings (0, 50, 150, 250, 500, 750, 1000, 1250, 1500, and 1750 watts) and 4 DC current settings (0, 20, 40, and 60 amps). At 60 amperes, the magnetic field strength measured with a Hall probe is approximately 400 gauss near the center of the plasma source.

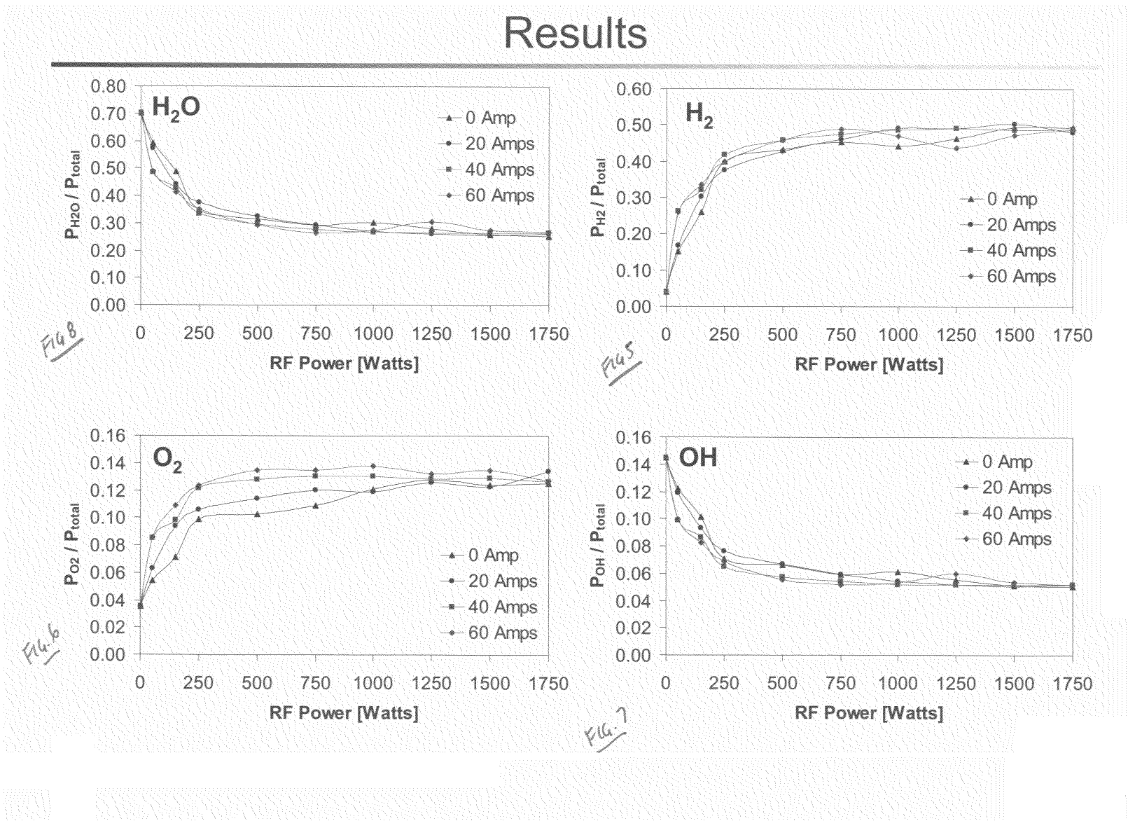

The main species in the plasma detected are: H₂O, H₂, O₂, OH, and N₂. Presence of N₂ comes from air trapped inside vacuum chamber 12 and air from the water vapor delivery system. FIGS. 5-8 show the ratio of the gas partial pressure over the total pressure as a function of RF power at four different DC current settings or equivalently four different magnetic field strength settings. The partial pressure ratio of hydrogen is shown in FIG. 5. The total pressure is the summation of all the partial pressures. The pressure ratio of hydrogen increases up to 60% as a function of RF power from 0 to 250 watts. This pressure ratio steadily increases to approximately 70% and this value is saturated near 500 watts. Similarly, FIG. 6 shows the pressure ratio for oxygen. Oxygen reaches a ratio of approximately 8%, and it is saturated at around the same RF power of 500 watts. It is also interesting to note that as RF power is increased, the ratio of hydroxyl is decreased as shown in FIG. 7. Hydroxyl pressure ratio saturates to 4% at RF power of 500 watts. FIG. 8 shows the best evidence of dissociation of water molecules in the plasma source. The water vapor pressure ratio starts at 70%. This value is not 100% because of the presence of air trapped inside vacuum chamber 12 and water delivery system 22. Water vapor pressure ratio decreases to approximately 20% at 500 watts, where saturation is observed. In conclusion, in terms of RF power setting, hydrogen and oxygen pressure ratios increase while the water and hydroxyl pressure ratios decreased.

Even though the exact dissociation mechanisms of the water molecules in this RF plasma source are still unknown, it is speculated that there is enough energy to break up the first O—H bonds, and possibly the second O—H bonds in H₂O molecules at low RF power. As more RF power is supplied, the remaining OH molecules are further dissociated into hydrogen and oxygen atoms, where they quickly combine with other hydrogen and oxygen atoms to form hydrogen and oxygen molecules.

While RF power significantly affects the dissociation of water molecules, the magnetic field is observed to have only a small effect at lower RF power and none at higher RF power. In FIGS. 5 through 8, at 1750 watts, the pressure ratio for each gas reaches one value regardless of the magnetic field strength, with the exception of oxygen. At lower RF power settings, oxygen is observed to have consistently higher pressure ratios at higher current settings in the entire range of RF power. This trend is also observed in hydrogen, but it is only observed at RF power less than 1000 watts. Similarly, hydroxyl and water vapor ratio pressures are observed to decrease as a function of magnetic field strength, and this trend is only observed at RF power less than 1000 watts.

### Conclusion

According to the principles of the present teachings, it has been demonstrated that apparatus 10 can be used to produce hydrogen from an inductive plasma source. At relatively high pressure (100 mtorr), results indicate that hydrogen production is not a strong function of axial magnetic field, and the partial pressures of hydrogen, oxygen, and hydroxyl saturate at approximately 500 watts and water vapor at 750 watts.

In some embodiments, plasma source 14 includes RF antenna 110, capable of operating in helicon mode. However, at 100 mtorr, this pressure is typically too high for helicon mode operation, yet hydrogen production is possible and seems to suggest that helicon mode operation may not be required. For future industrial application of hydrogen production using this method, it is favorable to be able to operate in inductive mode rather than in helicon mode, or to consider higher-pressure plasma sources; e.g., DBD devices. The hydrogen yield gained through inductive mode can be significantly higher than in helicon mode because the total gas throughput is higher in inductive mode.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. An apparatus for the disassociation of hydrogen from water vapor, said apparatus comprising:
a water vapor source outputting water vapor;
a plasma source outputting a plasma, said plasma impacting said water vapor, said plasma causing hydrogen within said water vapor to disassociate from oxygen;
a collection device collecting said hydrogen disassociate from said water vapor.

2. The apparatus according to claim 1 wherein said plasma source comprises:
a first power source;
a plurality of magnetic coils electrically coupled to said first power source;
a tubular member generally disposed within said plurality of magnetic coils, said tubular member receiving said water vapor.

3. The apparatus according to claim 2 wherein said plasma source can be operated in helicon mode and further comprises:
an RF antenna disposed between said tubular member and said plurality of magnetic coils;
a second power source operably coupled to said RF antenna.

4. The apparatus according to claim 3, further comprising:
a matching network electrically coupled between said helical antenna and said second power source, said matching network matching an impedance of said power supply and said RF antenna.

5. The apparatus according to claim 2 wherein said tubular member is a quartz tube.

6. The apparatus according to claim 1, further comprising:
a detector device operably coupled to said collection device, said detector device monitoring said disassociation of said hydrogen from said water vapor.

7. The apparatus according to claim 6 wherein said detector device is a residual gas analyzer.

8. The apparatus according to claim 1 wherein said plasma source is an RF plasma source.

9. The apparatus according to claim 1 wherein said collection device is a vacuum chamber.

10. The apparatus according to claim 1 wherein said collection device is maintained at atmospheric pressure.

11. The apparatus according to claim 1 wherein said collection device is maintained at a positive pressure.

12. A method of disassociating hydrogen from water vapor, said method comprising:
outputting a plasma from a plasma source, said plasma impacting a water vapor thereby causing hydrogen within said water vapor to be disassociated from oxygen within said water vapor; and
collecting said hydrogen.

13. The method according to claim 12 wherein said outputting a plasma from a plasma source comprises:
energizing a plurality of magnetic coils generally surrounding a tubular member, said tubular member receiving said water vapor.

14. The method according to claim 12 wherein said outputting a plasma from a plasma source comprises:
energizing a plurality of magnetic coils generally surrounding a tubular member, said tubular member receiving said water vapor; and
energizing a helical antenna disposed between said plurality of magnetic coils and said tubular member.

15. The method according to claim 12, further comprising:
generating said water vapor.

16. The method according to claim 12, further comprising:
detecting said disassociation of said hydrogen from said water vapor.
